(19) United States
(12) Patent Application Publication
(10) Pub. No.: US 2025/0164971 A1
(43) Pub. Date: May 22, 2025

(54) MASTER INTERFACE UNIT

(71) Applicant: Absolute Machine Tools, Lorain, OH (US)

(72) Inventor: Jeffrey Lee BENNETT, Lebanon, OH (US)

(73) Assignee: Absolute Machine Tools, Lorain, OH (US)

(21) Appl. No.: 18/513,770

(22) Filed: Nov. 20, 2023

(51) Int. Cl. G05B 19/418

(52) U.S. Cl. CPC G05B 19/41825

(57) ABSTRACT

A master interface unit for interfacing a computer numerical control (CNC) machine and a robot. The master interface unit has a robot communication interface configured to communicatively connect with the robot via a wired robot communication cable, a CNC communication interface configured to communicatively connect with the CNC machine via a wired machine communication cable, a network interface configured to communicate CNC code via the internet and processor circuitry. The processor circuitry coordinates communication between the robot and the CNC machine and updates the CNC machine. The processor circuitry determines a CNC communication protocol based on received incoming CNC communication signals, receives incoming robot communication signals, generates outgoing CNC signals having the determined CNC communication protocol and based on the received incoming robot communication signals, sends the CNC communication signals to the CNC machine, receives CNC communication signals from the CNC, generates and sends robot communications signals to the robot.

### TECHNICAL FIELD

The present disclosure relates generally to computer numerical control (CNC) machines and robots and more particularly to a unit for interfacing CNC machines and robots.

### BACKGROUND

In many advanced manufacturing setups, computer numerical control (CNC) machines are used to perform intricate tasks on workpieces, while robots (e.g., robotic arms) are integrated to automate material handling, feeding the CNC machine, and removing finished pieces. This kind of automation increases efficiency, ensures consistent quality, and minimizes human intervention, especially in repetitive and potentially hazardous tasks.

Standalone industrial robots are frequently added to existing CNC machine setups for material handling related to the CNC machine. These robots can be mounted on pedestals or rails, allowing them to service multiple machines if needed. In such setups, the robot may pick up raw material or unprocessed workpieces from a conveyor belt, bin, or pallet, using grippers or vacuum systems. The robot places the workpiece in the CNC machine's work holding device and the CNC machine, under its controller's guidance, processes the workpiece. Once the CNC operation is complete, the robot may remove the finished part. For example, the robot might place the finished part in a bin, on a conveyor for further processing, or in an inspection area.

### SUMMARY

Both computer numerical control (CNC) controllers and robot controllers need to exchange signals to ensure smooth operations. For instance, the CNC controller might send a signal indicating the machine has finished processing, prompting the robot to unload the workpiece. Many modern CNC controllers and robotic controllers communicate using Ethernet/IP or similar industrial communication protocols. These are used to connect various components, allowing them to communicate seamlessly. Examples include PROFIBUS, PROFINET, or Modbus. The present disclosure provides a master interface unit for coordinating communication between a CNC controller and a robot.

The present disclosure provides a master interface unit for interfacing a computer numerical control (CNC) machine and a robot. The master interface unit communicates with the robot via a wired robot communication cable and with the CNC machine via a wired machine communication cable. The processor circuitry coordinates communication between the robot and the CNC machine and updates the CNC machine using the received CNC code.

While a number of features are described herein with respect to embodiments of the invention; features described with respect to a given embodiment also may be employed in connection with other embodiments. The following description and the annexed drawings set forth certain illustrative embodiments of the invention. These embodiments are indicative, however, of but a few of the various ways in which the principles of the invention may be employed. Other objects, advantages, and novel features according to aspects of the invention will become apparent from the following detailed description when considered in conjunction with the drawings.

### BRIEF DESCRIPTION OF THE DRAWINGS

The annexed drawings, which are not necessarily to scale, show various aspects of the invention in which similar reference numerals are used to indicate the same or similar parts in the various views.

FIG. 1 is a block diagram of an exemplary embodiment of a system for interfacing a computer numerical control (CNC) machine and a robot using a master interface unit.

FIG. 2 is a flowchart for a method for interfacing a computer numerical control (CNC) machine and a robot using a master interface unit.

FIG. 3 is a flowchart depicting a method performed by the processor circuitry for coordinating communication between the robot and the CNC machine.

FIG. 4 is a flow chart depicting programming of the CNC machine by the processor circuitry.

The present invention is described below in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

### DETAILED DESCRIPTION

The master interface unit (MIU) is a communication device that establishes communication between the robot and a computer numerical control (CNC) machine. When performing an initial setup of a robot and a CNC machine, a technician is frequently required to go on site to perform the setup. The present disclosure provides an apparatus for simplifying this setup and, e.g., enabling this setup to be performed remotely.

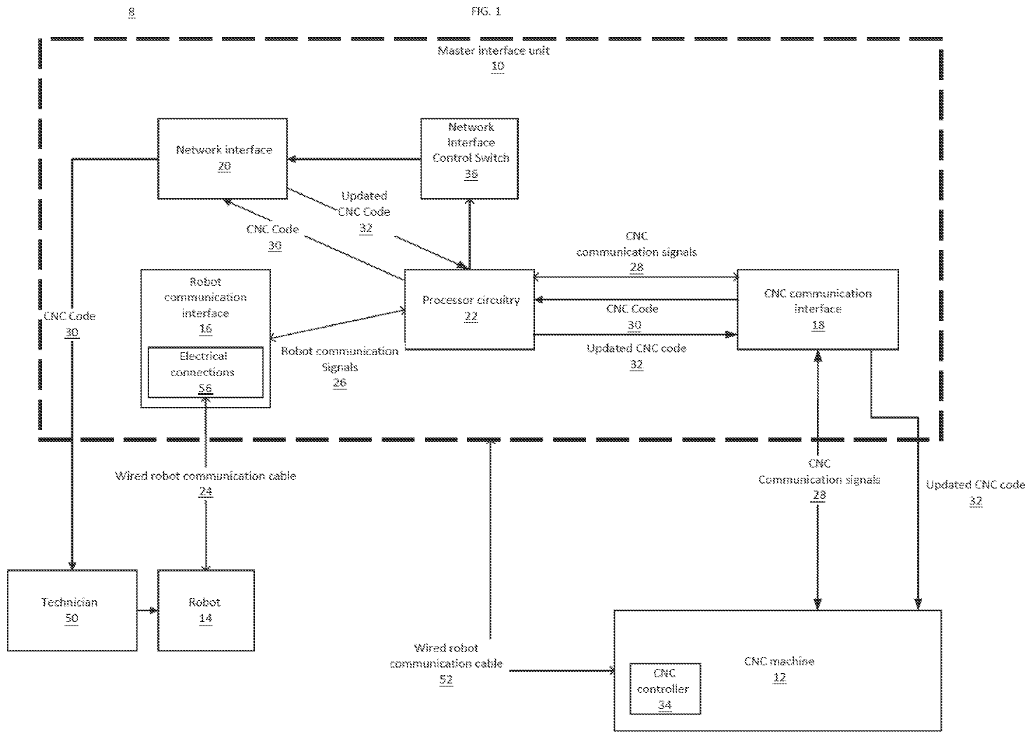

Turning to FIG. 1, a system 8 is shown for using a master interface unit 10 to interface a computer numerical control (CNC) machine 12 and a robot 14. The master interface unit 10 includes a robot communication interface 16, a CNC communication interface 18, and processor circuitry 22. The processor circuitry 22 is configured to coordinate communication between the robot 14 and the CNC machine 12, and updates the CNC machine 12. The robot communication interface 16 communicatively connects the master interface unit 10 with the robot 14 via a wired robot communication cable 24. The robot communication interface 16 includes electrical connections 56 for electrically interfacing with the wired robot communication cable 24. The CNC communication interface 18 is configured to communicatively connect with the CNC 12 via a wired machine communication cable 52.

The processor circuitry 22 communicates between the robot 14 by using a robot communication protocol and the CNC machine 12 by using a CNC communication protocol. The processor circuitry 22 receives incoming CNC communication signals 28 from the CNC machine 12 via the CNC communication interface 18. The processor circuitry 22 determines a CNC communication protocol based on the received incoming CNC communication signals 28. The processor circuitry 22 may determine the CNC communication protocol based on any suitable method. For example, the processor circuitry 22 may determine the CNC communication protocol based on electrical connections of the master interface unit that the CNC communication signals 28 were received on, based on a structure of the communication signals 28 (e.g., a packet type, header information, etc.).

The processor circuitry 22 also receives incoming robot communication signals 26 from the robot communication interface 16. The processor circuitry 22 then generates outgoing CNC communication signals 28 that have the determined CNC communication protocol based on the received incoming robot communication signals 26. The processor circuitry 22 generates outgoing robot communication signals 26 based on the received incoming CNC communication signals 28. The outgoing robot communication signals 26 have the robot communication protocol and are sent to the robot via the robot communication interface 16.

In addition to facilitating communication between the CNC machine 12 and the robot 14, the processor circuitry 22 also updates the CNC machine 12. The processor circuitry 22 receives CNC code 30 from the CNC machine 12 via the CNC communication interface 18. The processor circuitry 22 outputs the received CNC code 30 (e.g., to a technician 50) and receives updated CNC code 32.

The master interface unit 10 may also include a network interface 20 configured to communicate the CNC code 30 via the internet. For example, the processor circuitry 22 may output the received CNC code by sending the received CNC code via the network interface 20. The processor may also receive the updated CNC code via the network interface 20. For example, the CNC code may be communicated to the technician 50 via the internet. The technician 50 may update the CNC code and send the CNC code back to the master interface unit 10 via the network interface 20.

The CNC machine 12 may be any suitable device adaptable for use in machining processes (e.g., remote and/or local devices). For example, the CNC machine 12 may comprise a milling machine, lathe, router, grinder, or laser cutter. The CNC machine 12 may include a CNC controller 34 that controls the CNC machine 12. For example, the outgoing CNC communication signals 28 may be sent from the master interface unit 10 to the CNC controller 34 of CNC machine 12 via the CNC communication interface 18. The CNC controller 34 may control the CNC machine 12 based on the received CNC communication signals 28. For example, the processor circuitry 22 of the master interface unit 10 may send the updated CNC code 32 to the CNC controller 34 of the CNC machine 12 via the CNC communication interface 18. The CNC controller 34 may receive, implement, and execute the updated CNC code 32.

The CNC controller 34 may have various implementations, such as a programmable logic controller (PLC). For example, the CNC controller 34 may include any suitable device, such as a processor (e.g., CPU), programmable circuit, integrated circuit, memory and I/O circuits, an application specific integrated circuit, microcontroller, complex programmable logic device, other programmable circuits, or the like. The CNC controller 34 may also include a non-transitory computer readable medium, such as random-access memory (RAM), a read-only memory (ROM), an erasable programmable read-only memory (EPROM or Flash memory), or any other suitable medium. Instructions for performing the method described below may be stored in the non-transitory computer readable medium and executed by the CNC controller 34.

The CNC code 30 may be written in any suitable computer programming language. For example, the CNC code 30 may be written in at least one of ladder logic programming, structured text language (STL), function block (FB), or function block diagram (FBD). That is, the CNC machine 12 may be controlled through ladder logic programming, allowing for the programming, monitoring, and modification of machine operations using a ladder diagram format.

The machine 12 maintains communication with the master interface unit 10 through the wired machine communication cable 52. The wired machine communication cable 52 may transmit a range of signal types, including but not limited to control signals, feedback data, and power supply. The wired machine communication cable 52 may comprise any suitable wired connector, such as a barrel connector, a multiconductor cable, a multicount cable, or an ethernet cable.

The robot 14 may be any suitable device suitable for functioning in conjunction with the CNC machine 12. For example, the robot 14 may be an industrial robot configured to execute a variety of tasks in coordination with the CNC machine 12. These tasks can include material handling (manipulating raw materials or finished parts), loading and unloading workpieces (transferring to and from the CNC machine 12), precision assembly (e.g., assembling where components fabricated by the CNC machine 12), quality inspection, etc. The robot 14 may include one or more of articulated robots, selective compliance assembly robot arm (SCARA) robots, cartesian robots, delta robots, collaborative robots (also referred to as cobots), etc.

The robot 14 maintains communication with the master interface unit 10 through the wired robot communication cable 24. The wired robot communication cable 24 may transmit a range of signal types, including but not limited to control signals, feedback data, and power supply. The wired robot communication cable 24 may comprise any suitable wired connector, such as a barrel connector or a multiconductor cable.

The master interface unit 10 may have a network interface control switch 36 for controlling the network interface 20 of the master interface unit 10. The network interface control switch 36 is configured to disable and enable the network interface 20 such that internet access to the master interface unit 10 is disabled when the network interface 20 is disabled by the network interface control switch 36. For example, to limit potential security breaches of the master interface unit 10, the network interface control switch 36 may effectively take the master interface unit 10 offline (i.e., inaccessible for internet-based attacks) when the network interface 20 is disabled by the network interface control switch 36. The network interface control switch 36 may be a hardware switch and/or a software switch. For example, the network interface control switch 36 may be a hardware switch (i.e., a physical button, switch, etc.) that automatically disables the network interface 20 after a duration of time. In this example, if a user enables the network interface 20 using the network interface control switch 36 by pushing a button, the network interface 20 may only be accessible for a particular duration of time (e.g., one hour, one day, three days, etc.) before the network interface control switch 36 automatically disables the network interface 20 again. The network interface control switch 36 may be controllable by the master interface unit 10. For example, while the network interface is enabled, the master interface unit 10 may receive instructions concerning a future enablement time period. That is, the master interface unit 10 may receive instructions to enable the network interface at a specific time to receive updated CNC code.

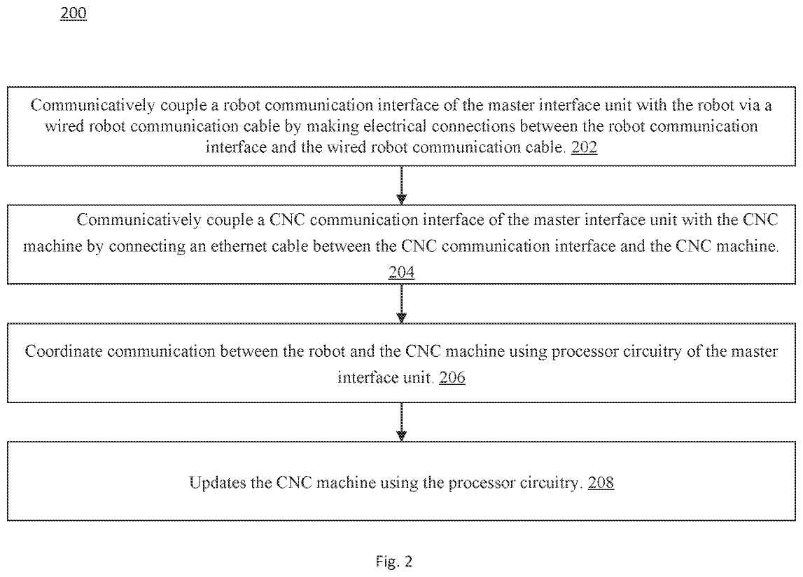

Turning to FIG. 2, a method 200 is shown for interfacing a computer numerical control (CNC) machine and a robot using a master interface unit 10. In step 202, a robot communication interface 16 of the master interface unit 10 is communicatively coupled with the robot 14 via a wired robot communication cable 24 by making electrical connections 56 between the robot communication interface 16 and the wired robot communication cable 24. In step 204, the CNC communication interface 18 of the master interface unit 10 is communicatively coupled with the CNC machine 12 by connecting a wired machine communication cable 52 between the CNC communication interface 18 and the CNC machine 12. In step 206, the processor circuitry 22 of the master interface coordinates communication between the robot 14 and the CNC machine 12. In step 208, the processor circuitry 22 updates the CNC machine 12.

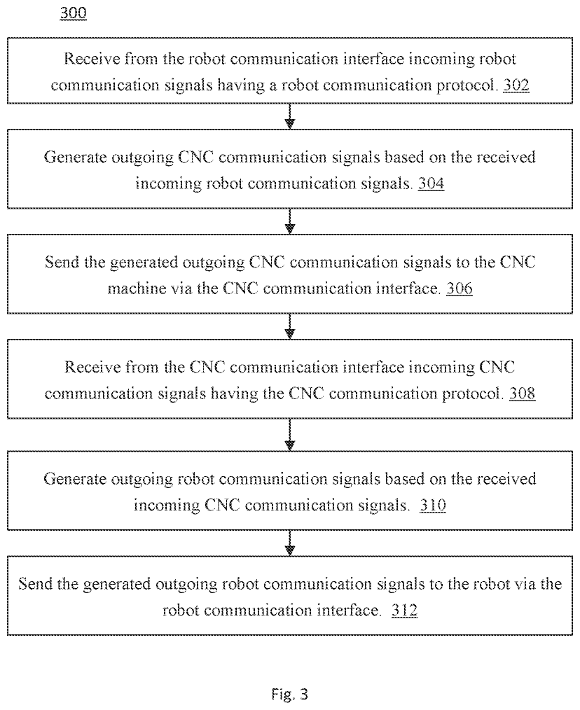

FIG. 3 describes an exemplary embodiment of how the processor circuitry 22 coordinates communication between the robot 14 and the CNC machine 12. Step 302 shows the processor circuitry 22 receiving incoming robot communication signals 26 having a robot communication protocol from the robot communication interface 16. In step 304, the processor circuitry 22 generates outgoing CNC communication signals based on the received incoming robot communication signals 26, wherein the generated outgoing CNC communications signals have a CNC communication protocol. In step 306, the processor circuitry 22 sends the generated outgoing CNC communication signals to the CNC machine 12 via the CNC communication interface 18 where the CNC controller receives them 34. In step 308, the processor circuitry 22 receives incoming CNC communications having the CNC communication protocol from the CNC communication interface 18. In step 310, the processor circuitry 22 generates outgoing robot communication signals 26 based on the received incoming CNC communication signals. In step 312, the processor circuitry 22 sends the outgoing robot communication signals 26 to the robot 14 via the robot communication interface 16.

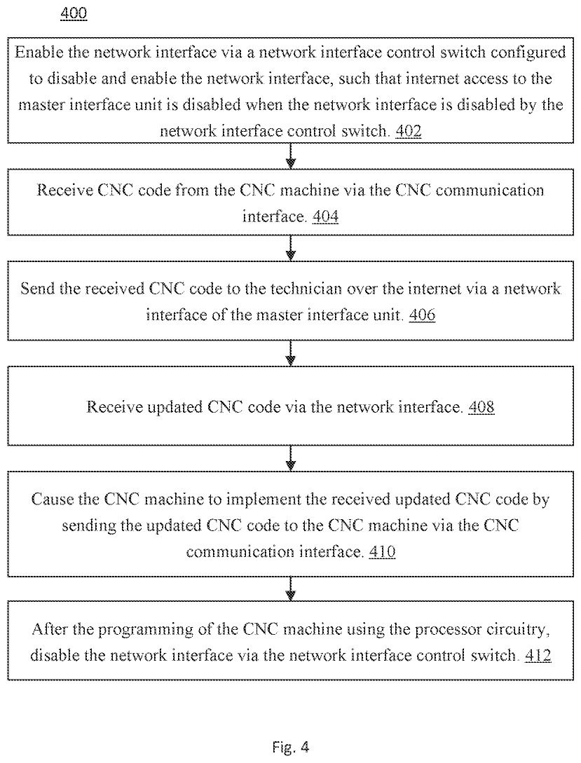

FIG. 4 depicts exemplary steps of how the processor circuitry 22 updates the CNC machine 12. In step 402, before the programming of the CNC machine 12, the processor circuitry 22 or a user enables the network interface 20 via the network interface control switch 36. In step 404, the processor circuitry 22 receives CNC code from the CNC machine 12 via the CNC communication interface 18. In step 406, the processor circuitry 22 sends the received CNC code to the technician 50 over the internet via a network interface 20 of the master interface unit 10. In step 408, the processor circuitry 22 receives the updated CNC code 32 via the network interface 20. In step 410, the processor circuitry 22 causes the CNC machine 12 to implement the received updated CNC code 32 by sending the updated CNC code 32 to the CNC machine 12 via the CNC communication interface 18.

The master interface unit 10 may be any suitable computer device capable of performing the functions and processing described herein. The processor circuitry 22 of the master interface unit may have various implementations. For example, the circuitry 22 may include any suitable device, such as a processor (e.g., CPU), programmable circuit, programmable logic controller (PLC), integrated circuit, memory and I/O circuits, an application specific integrated circuit, microcontroller, complex programmable logic device, other programmable circuits, or the like. The circuitry 22 may also include a non-transitory computer readable medium, such as random-access memory (RAM), a read-only memory (ROM), an erasable programmable read-only memory (EPROM or Flash memory), or any other suitable medium. Instructions for performing the method described herein may be stored in the non-transitory computer readable medium and executed by the circuitry 22. The circuitry 22 may be communicatively coupled to the computer readable medium and network interface through a system bus, mother board, or using any other suitable structure known in the art.

The network interface 20 may comprise a wireless network adaptor, an Ethernet network card, or any suitable device that provides an interface to a network. The network interface 20 may be communicatively coupled to the computer readable medium, such that the network interface 20 is able to send data stored on the computer readable medium across the network and store received data on the computer readable medium 20. The network interface 20 may also be communicatively coupled to the circuitry such that the circuitry is able to control operation of the network interface 20. The network interface 20, computer readable medium, and circuitry may be communicatively coupled through a system bus, mother board, or using any other suitable manner as will be understood by one of ordinary skill in the art.

All ranges and ratio limits disclosed in the specification and claims may be combined in any manner. Unless specifically stated otherwise, references to “a,” “an,” and/or “the” may include one or more than one, and that reference to an item in the singular may also include the item in the plural.

Although the invention has been shown and described with respect to a certain embodiment or embodiments, equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A master interface unit for interfacing a computer numerical control (CNC) machine and a robot, comprising:
a robot communication interface configured to communicatively connect with the robot via a wired robot communication cable, wherein the robot communication interface includes electrical connections for electrically interfacing with the wired robot communication cable;
a CNC communication interface configured to communicatively connect with the CNC machine via a wired machine communication cable;
processor circuitry configured to:
coordinate communication between the robot and the CNC machine by:
receiving incoming CNC communication signals from the CNC machine via the CNC communication interface;
determining a CNC communication protocol based on the received incoming CNC communication signals;
receiving from the robot communication interface incoming robot communication signals having a robot communication protocol;
generating outgoing CNC communication signals based on the received incoming robot communication signals, wherein the generated outgoing CNC communication signals have the determined CNC communication protocol;
sending the generated outgoing CNC communication signals to the CNC machine via the CNC communication interface;
generating outgoing robot communication signals based on the received incoming CNC communication signals, wherein the generated outgoing robot communication signals have a robot communication protocol; and
send the generated outgoing robot communication signals to the robot via the robot communication interface;
programming the CNC machine by:
receiving the CNC code from the CNC machine via the CNC communication interface;
outputting the received CNC code;
receiving updated CNC code; and
causing the CNC machine to implement the received updated CNC code by sending the updated CNC code to the CNC machine via the CNC communication interface.

2. The master interface unit of claim 1, wherein:
the CNC machine includes a CNC controller; and
the CNC communication interface communicates with the CNC controller, such that the sent outgoing CNC communication signals are received by the CNC controller.

3. The master interface unit of claim 2, wherein the updated CNC code is received and executed by the CNC controller machine.

4. The master interface unit of claim 3, wherein the CNC code comprises ladder logic and the CNC controller comprises a programmable logic controller (PLC).

5. The medical instrument of claim 1, further comprising a network interface configured to communicate CNC code via the internet, wherein:
the processor circuitry is further configured to:
output the received CNC code by sending the received CNC code via the network interface; and
receive the updated CNC code via the network interface.

6. The master interface unit of claim 5, further comprising a network interface control switch configured to disable and enable the network interface, such that internet access to the master interface unit is disabled when the network interface is disabled by the network interface control switch.

7. The master interface unit of claim 6, wherein the network interface control switch is a hardware switch.

8. The master interface unit of claim 1, wherein the wired robot communication cable comprises at least one of a barrel connector or a multiconductor cable.

9. A method for interfacing a computer numerical control (CNC) machine and a robot using a master interface unit, comprising:
communicatively coupling a robot communication interface of the master interface unit with the robot via a wired robot communication cable by making electrical connections between the robot communication interface and the wired robot communication cable;
communicatively coupling a CNC communication interface of the master interface unit with the CNC machine by connecting a wired machine communication cable between the CNC communication interface and the CNC machine;
coordinating communication between the robot and the CNC machine using processor circuitry of the master interface unit by:
receiving incoming CNC communication signals from the CNC machine via;
determining a CNC communication protocol based on the received incoming CNC communication signals;
receiving from the robot communication interface incoming robot communication signals having a robot communication protocol;
generating outgoing CNC communication signals based on the received incoming robot communication signals, wherein the generated outgoing CNC communication signals have the determined CNC communication protocol;
sending the generated outgoing CNC communication signals to the CNC machine via the CNC communication interface;
receiving from the CNC communication interface incoming CNC communication signals having the CNC communication protocol;
generating outgoing robot communication signals based on the received incoming CNC communication signals, wherein the generated outgoing robot communication signals have a robot communication protocol; and
send the generated outgoing robot communication signals to the robot via the robot communication interface;
programming the CNC machine using the processor circuitry by:
receiving CNC code from the CNC machine via the CNC communication interface;
outputting the received CNC code;
receiving updated CNC code; and
causing the CNC machine to implement the received updated CNC code by sending the updated CNC code to the CNC machine via the CNC communication interface.

10. The method of claim 9, wherein:
the CNC machine includes a CNC controller; and
the CNC communication interface communicates with the CNC controller, such that the sent outgoing CNC communication signals are received by the CNC controller.

11. The method of claim 10, wherein the updated CNC code is received and executed by the CNC controller machine.

12. The method of claim 11, wherein the CNC code comprises ladder logic and the CNC controller comprises a programmable logic controller (PLC).

13. The method of claim 8, wherein:
the outputting of the received CNC code is performed by sending the received CNC code via a network interface of the master interface unit; and
the updated CNC code is received via the network interface

14. The method of claim 13, further comprising:
before the programming of the CNC machine using the processor circuitry, enabling the network interface via a network interface control switch configured to disable and enable the network interface, such that internet access to the master interface unit is disabled when the network interface is disabled by the network interface control switch; and
after the programming of the CNC machine using the processor circuitry, disabling the network interface via the network interface control switch.

15. A system for interfacing a computer numerical control (CNC) machine and a robot using a master interface unit, comprising:
the CNC machine comprising a communication interface for communicating with the master interface unit and outputting CNC code, and a CNC controller for controlling operations of the CNC machine;
the robot comprising a data interface for communicating with the master interface unit;
the master interface unit comprising:
a robot communication interface configured to communicatively connect with the robot via a wired robot communication cable, wherein the robot communication interface includes electrical connections for electrically interfacing with the wired robot communication cable;
a CNC communication interface configured to communicatively connect with the CNC machine via a wired machine communication cable;
processor circuitry configured to:
receive incoming CNC communication signals from the CNC machine via the CNC communication interface;
determine a CNC communication protocol based on the received incoming CNC communication signals;
coordinate communication between the robot and the CNC machine by:
receiving from the robot communication interface incoming robot communication signals having a robot communication protocol;
generating outgoing CNC communication signals based on the received incoming robot communication signals, wherein the generated outgoing CNC communication signals have the determined CNC communication protocol;
sending the generated outgoing CNC communication signals to the CNC machine via the CNC communication interface;
receiving from the CNC communication interface incoming CNC communication signals having the CNC communication protocol;
generating outgoing robot communication signals based on the received incoming CNC communication signals, wherein the generated outgoing robot communication signals have a robot communication protocol; and
sending the generated outgoing robot communication signals to the robot via the robot communication interface;
programming the CNC machine by:
receiving the CNC code from the CNC machine via the CNC communication interface;
outputting the received CNC code to;
receiving updated CNC code; and
causing the CNC machine to implement the received updated CNC code by sending the updated CNC code to the CNC machine via the CNC communication interface;
wherein the communication interface of the CNC machine is configured to receive the updated CNC code and the CNC controller is configured to execute the received updated CNC code.

16. The system of claim 15, wherein the CNC code comprises ladder logic and the CNC controller comprises a programmable logic controller (PLC).

17. The system of claim 15, wherein the master interface unit further comprises a network interface configured to communicate CNC code via the internet, wherein:
the processor circuitry of the master interface unit is further configured to:
output the received CNC code by sending the received CNC code via the network interface; and
receive the updated CNC code via the network interface.

18. The system of claim 17, further comprising a network interface control switch configured to disable and enable the network interface of the master interface unit, such that internet access to the master interface unit is disabled when the network interface is disabled by the network interface control switch.

19. The system of claim 18, wherein the network interface control switch is a hardware switch.

20. The system of claim 15, wherein the wired robot communication cable comprises at least one of a barrel connector or a multiconductor cable.
